(19) United States
(12) Patent Application Publication
(10) Pub. No.: US 2025/0365778 A1
(43) Pub. Date: Nov. 27, 2025

(54) RECEIVER DEFENSE USING CLEAR-TO-SEND ACKNOWLEDGMENT FRAMES

(71) Applicant: Cypress Semiconductor Corporation, San Jose, CA (US)

(72) Inventors: Hsu-Hui Wang, Taipei (TW); Rakesh Taori, McKinney, TX (US)

(73) Assignee: Cypress Semiconductor Corporation, San Jose, CA (US)

(21) Appl. No.: 18/672,214

(22) Filed: May 23, 2024

(51) Int. Cl. H04W 74/0833; H04W 72/0446

(52) U.S. Cl. CPC H04W 74/085; H04W 72/0446

(57) ABSTRACT

A method includes receiving, by an access point (AP) device operating in dual bands, a request-to-send (RTS) frame from a peer wireless device. The method includes determining whether a channel-access period specified by the RTS frame exceeds a remaining on-channel time for a wireless band during time-division multiplexing transmission. The method includes, in response to the channel-access period of the RTS frame exceeding the remaining on-channel time, transmitting, by the AP device, a clear-to-send acknowledgement (CTS-A) frame that reserves the channel-access period for the AP device.

### TECHNICAL FIELD

This disclosure relates to wireless devices and, more specifically, to receiver defense using clear-to-send acknowledgment frames.

### BACKGROUND

Clear to Send (CTS) in the context of a wireless receiver may include a signal used in serial communications, which is also applicable to wireless communications. In wireless communications, CTS may be employed to conduct flow control. When a wireless device is ready to receive data, the wireless device sends a CTS frame to the transmitting device to indicate that the transmitting device can start sending the data. This process helps in managing the data flow, prevents data loss, and ensures the receiver is not overwhelmed with more data than the receiver can handle. The CTS frame is often paired with a Request-to-Send (RTS) frame, where the transmitting device signals an intention to send data and waits for the CTS frame from the receiving device before proceeding to send the data. This RTS/CTS interplay mechanism, when employed in network environments where multiple devices communicate over the same channel, helps to avoid collisions and manage network traffic efficiently.

### BRIEF DESCRIPTION OF THE DRAWINGS

FIG. 1 is an operational diagram of exemplary virtual simultaneous dual band (VSDB) operation of a dual-access point (AP) device according to an embodiment.

FIG. 2 is an operational diagram of exemplary VSDB operation of an AP device, according to an embodiment, in which a channel access period exceeds available ON time of a first band.

FIG. 3 is an operational diagram of exemplary VSDB operation of an AP device, according to an embodiment, in which there is insufficient time to send out a CTS-A frame.

FIG. 4 is an operational diagram of exemplary VSDB operation of an AP device, according to an embodiment, in which a CTS-A frame takes no effect due to a previously transmitted CTS frame.

FIG. 5 is an operational diagram of exemplary VSDB operation of an AP device, according to an embodiment, in missing expected CTS frames cause the peer wireless device to continue sending RTS frames.

FIG. 6A is an operational diagram of exemplary VSDM operation of an AP device where a CTS-A frame is sent out in response a channel-access period of an RTS frame exceeding a remaining on-channel time according to some embodiments.

FIG. 6B is the operational diagram of the exemplary VSDM operation of the AP device of FIG. 6A, illustrating a time period during which the CTS-A frame is to be sent out according to some embodiments.

FIG. 7 is a flow chart of a method for an AP device to conduct receiver defense using CTS-A frames according to some embodiments.

FIG. 8 is a timing diagram illustrating operation of the receiver defense when an active channel (e.g., particular wireless band) is near an off-channel transition according to some embodiments.

FIG. 9 is a timing diagram illustrating operation of the receiver defense when an on-channel time period of a first wireless band is within a predetermined period of ending according to at least one embodiment.

FIG. 10 is a flow chart of a method of the AP device conducting receiver defense depending on whether an on-channel time period of a first wireless band is within a predetermined period of ending according to at least one embodiment.

FIG. 11 is a flow chart of a method of the AP device conducting receiver defense when an on-channel time period of a first wireless band is within a predetermined period of ending according to some embodiments.

FIG. 12 is a simplified block diagram of a wireless network 1100 in which an example AP device interacts with other wireless devices according to various embodiments.

### DETAILED DESCRIPTION

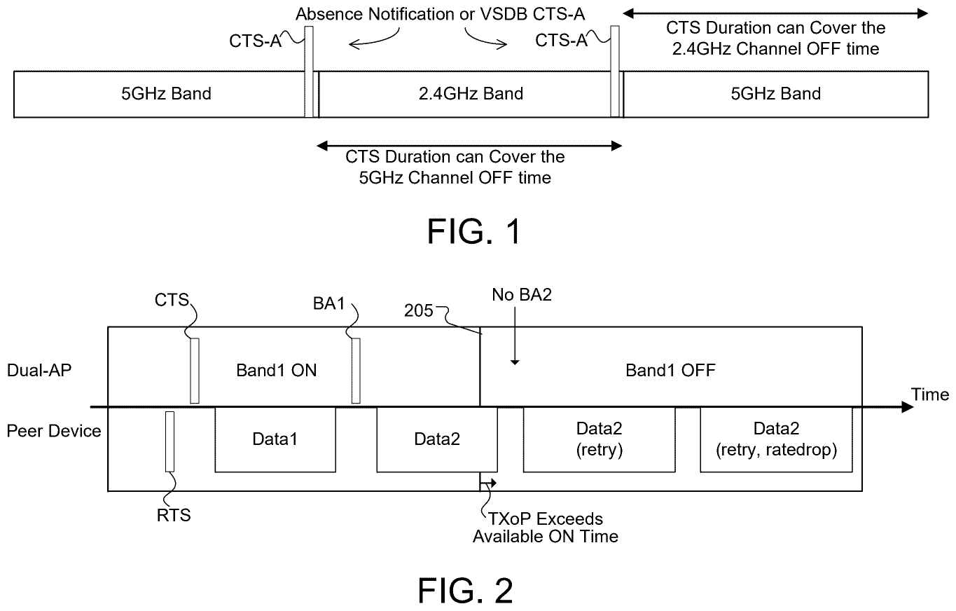

The following description sets forth numerous specific details such as examples of specific systems, devices, components, methods, and so forth, in order to provide a good understanding of various embodiments of conducting receiver (RX) defense using CTS acknowledgment (CTS-A) frames, also known as CTS to nowhere or CTS to self. In VSDB operation, as illustrated in FIG. 1, a wireless access point device (e.g., AP device) may apply time division multiplexing (TDM) to switch between two frequency bands, typically 2.4 gigahertz (GHz) and 5 GHz, although others are envisioned. Thus, the wireless AP device functions as a dual-AP device, but will be referred to herein as an “AP device” for simplicity.

So that a peer wireless device (e.g., wireless station or STA) is informed of switching between the bands, the AP device may send out an absence notification CTS-A frame to announce a channel switch, e.g., from 2.4 GHz to 5 GHz or from 5 GHz to 2.4 GHz. The peer wireless device (or multiple peer wireless devices) may be silent for a duration of time specified in the absence notification CTS-A frame because the channel is unavailable to the peer wireless device(s) during that time. For example, the AP device may send the absence notification CTS-A frame at the end of the 5 GHz band period having a duration that covers the 5 GHz off-channel time. The AP device may similarly send the absence notification CTS-A frame at the end of the 2.4 GHz band period having a duration that covers the 2.4 GHz band off-channel time.

In some situations, if the AP device is unable to successfully communicate the channel switch announcement with an absence notification CTS-A frame (for reasons that will be discussed later), the peer wireless device may be tied up with fruitless attempts to transmit data when the band of interest is in an off-channel period of time. More specifically, the peer wireless device may continue to either send data (e.g., that the peer wireless device was previously cleared to send) or send RTS frames to retry getting a CTS frame that will allow the peer wireless device to start sending data. For example, if the CTS-A at the end of the 5 GHz band period is not successfully transmitted by the AP device and received by the peer wireless device, then the peer wireless device may continue to send RTS frames to retry sending data during the 2.4 GHz band on-channel time. Repeated sending of data and/or RTS frames may cause the data rate of the peer wireless device to be downgraded (e.g., reduced) due to a rate selection algorithm or the like. In general, however, if an RTS attempt fails, the peer wireless devices drops its data rate to try to cause a successful RTS attempt, e.g., getting a CTS back from the AP device. A drop in data rate may cause slower Internet speeds, increased latency, reduced network throughput, and generally poor quality of service (QOS), particularly for high throughout streaming, e.g., which may lead to decreased quality in calls or video.

To resolve these and other deficiencies with known approaches to channel transition announcements in VSDB operation of an AP device, according to disclosed embodiments, the present disclosure sets forth methods, generally to be implemented by the AP device, that test for closeness to the end-of-on-channel time of a frequency band and, when satisfying certain criterion (or criteria), rather than granting a channel-access period to the peer wireless device, transmits a CTS-A frame to take ownership of the channel. By transmitting a particularly formatted CTS-A frame, the peer wireless device is denied access to the channel and stops requesting the channel-access period. In some embodiments, the channel-access period is known as a transmission opportunity (TXoP).

More specifically, in some embodiments, an AP device in VSDB operation receives an RTS frame from a peer wireless device. In some embodiments, the AP device determines whether a channel-access period specified by the RTS frame exceeds a remaining on-channel time for a wireless band during time-division multiplexing transmission. In response to the channel-access period of the RTS frame exceeding the remaining on-channel time, the AP device transmits a CTS-A frame that reserves the channel-access period for the AP device.

Further, to avoid scenarios where time before transition between bands in VSDB operation runs out before a CTS-A frame can be successfully transmitted and received, the AP device may also detect that an on-channel time period of a wireless band is within a predetermined period of ending. The AP device may also, in response to detecting this closeness to the on-channel time period ending (even despite no pending RTS from the peer wireless device), transmit a CTS-A frame that reserves a channel-access period for the AP device. In proactively taking ownership of the channel operating within a particular wireless band, the AP device may prophylactically prevent any last-minute grant of channel access to a peer wireless device.

The present disclosure includes a number of advantages, including the ability to avoid data rate reduction of peer wireless devices due to repeated attempts to send data during an off period of a channel in VSDB operation of an AP device through which the peer wireless devices are connected. By avoiding such drops in data rate, these peer wireless devices can maintain higher data speeds, reduce latency, and increase throughput, all which ultimately improve QoS for these peer wireless devices. Additional advantages will be apparent to those skilled in the art of VSDB-based wireless communication and are discussed further below.

FIG. 2 is an operational diagram of exemplary VSDB operation of an AP device, according to an embodiment, in which a channel access period exceeds available on time of a first band. As can be seen, after the AP device transmits a CTS frame in response to an RTS frame, the peer wireless device begins sending data. After each data frame is received, a block acknowledgment (BA) is transmitted by the AP device to the peer wireless device, acknowledging receipt of the data. As the second block of data (Data2) takes so long to transmit, the second block data transmission overlaps with the transition 205 between a first band on-channel period to a first band off-channel period (e.g., for a first frequency band). This may occur because the channel access period (e.g., the TXOP time) exceeds the available on-channel time for the band. The result in this scenario is that the peer wireless device may continue to retry sending the second block of data, resulting in rate drop of the peer wireless device, as mentioned. For example, the peer wireless device retries to transmit Data2 multiple times during the first band off-channel period, resulting in the rate drop by the end of the first band off-channel period.

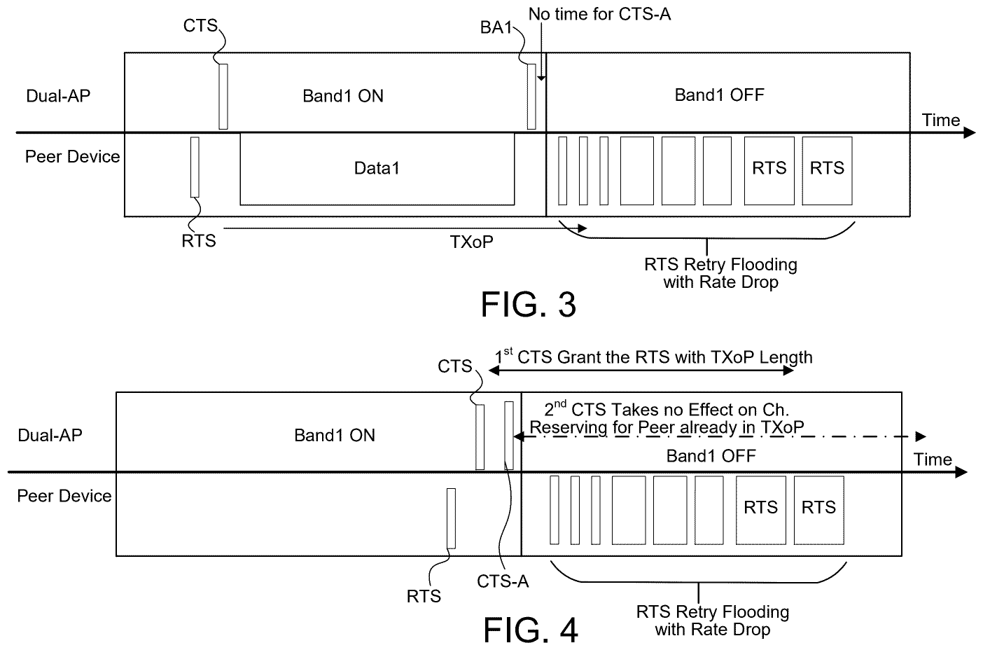

FIG. 3 is an operational diagram of exemplary VSDB operation of an AP device, according to an embodiment, in which there is insufficient time to send out a CTS-A frame. In this scenario, although the peer wireless device completes transmission of the first data block within the first band on-channel period (Band1 ON), there is only sufficient time for the AP device to send a block acknowledgment (BA1). There is not sufficient time to send a CTS-A frame ahead of the off-band period (Band1 OFF). Even if there were time to transmit the CTS-A frame, the channel access period may overwhelm any CTS-A frame such that the peer wireless device does not receive the CTS-A frame. As a result, the peer wireless device may perform RTS retry flooding during the first band off-channel period to continue use of the channel previously granted with a corresponding rate drop. The rate drop may be due to the peer wireless device being downgraded as a result of a rate selection algorithm acting on the RTS retry flooding. Due to the rate drop, each successive RTS that is transmitted is illustrated to take more time (longer RTS period).

FIG. 4 is an operational diagram of exemplary VSDB operation of an AP device, according to an embodiment, in which a CTS-A frame takes no effect due to a previously transmitted CTS frame. At a late stage in the on-channel period for the first band, a CTS frame is transmitted by the AP device to the peer wireless device. Because the peer wireless device has gained access ownership to the channel (TXoP) for a particular length of time, sending a follow-on CTS-A frame to announce the channel on time ending has no effect. As a result of failing in a last-minute attempt to reserve the channel, the peer wireless device may continue sending RTS frame retries. Similar to the example of FIG. 3, the peer wireless device experiences a rate drop due to RTS retry flooding during the first band off-channel period.

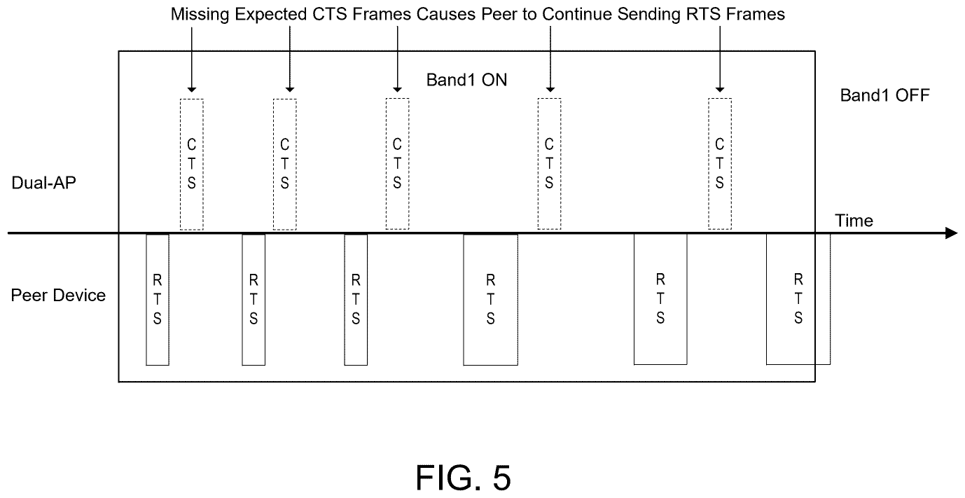

FIG. 5 is an operational diagram of exemplary VSDB operation of an AP device, according to an embodiment, wherein missing expected CTS frames cause the peer wireless device to continue sending RTS frames. In some time-critical scenarios, the RTS frame access request received from the peer wireless device should be denied. But ignoring the RTS frame access request may cause the peer wireless device to transmit multiple RTS frame retries, which again, may cause a peer wireless device rate drop.

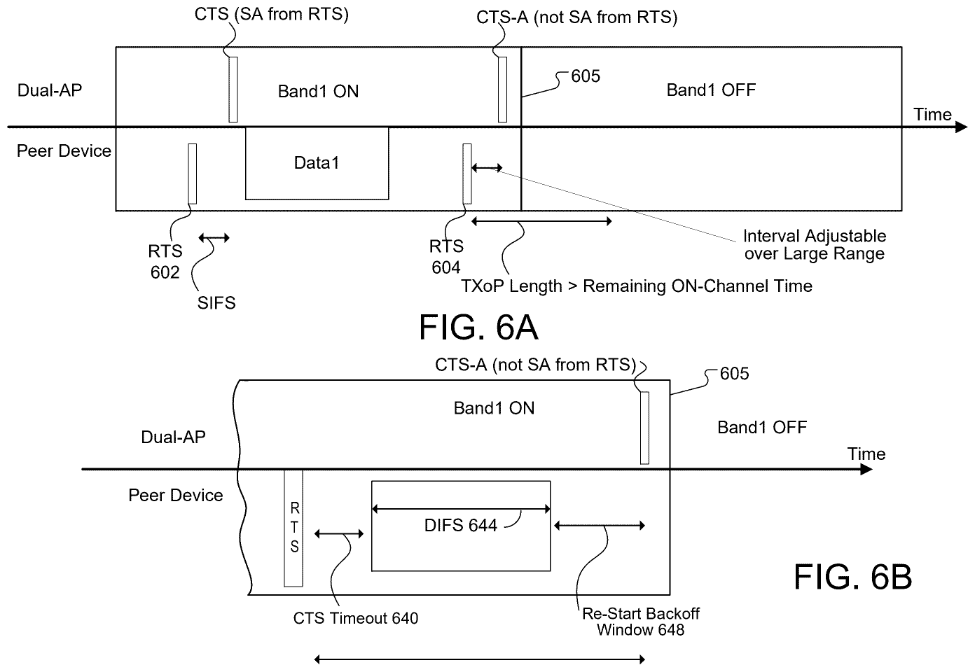

FIG. 6A is an operational diagram of exemplary VSDM operation of an AP device where a CTS-A frame is sent out in response a channel-access period of an RTS frame exceeding a remaining on-channel time according to some embodiments. For example, in some embodiments, the AP device performs a test to determine closeness to the end-of-on-channel time of a frequency band. In embodiments, when satisfying certain criterion (or criteria), rather than granting a channel-access period to the peer wireless device, the AP device transmits a CTS-A frame to take ownership of the channel. By transmitting a particularly-formatted CTS-A frame, the peer wireless device is denied access to the channel and stops requesting the channel-access period. In some embodiments, the channel-access period is known as a transmission opportunity (TXoP) period.

For example, with reference to the operational diagram of FIG. 6A, after interchange of a first RTS frame 602 and a regular CTS frame, a first data block (Data1) is transmitted by the peer wireless device. After transmission of the first data block, the peer wireless device transmits a second RTS frame 604 to the AP device. At this point, the AP device may perform the test to determine closeness to the end-of-on-channel time 605 of a frequency band (e.g., end of Band1 ON time period). In one embodiment, if the channel-access period of the second RTS frame 604 exceeds the remaining on-channel time, then a criterion is not satisfied and the AP device knows that there is not sufficient remaining on-channel time to grant the RTS request. Thus, in response to not satisfying this end-of-on-channel time criterion, the AP device may transmit a CTS-A frame with a destination address not from the RTS (a source address from some device other than the peer wireless device and other than the AP device) that reserves the channel-access period for the AP device. In this way, the AP device takes ownership of the channel-access (or TXoP) period that extends into the off-channel transition.

In some embodiments, reserving the channel-access period with the CTS-A frame takes access to the channel-access period away from the peer wireless device. Further, in some embodiments, the CTS-A frame is generated with a destination address that is other than a source address included within the RTS frame and with a CTS duration that is different than the duration for a typical CTS frame. More specifically, when the CTS frame is to respond to an RTS frame, the duration should be adopted from the RTS frame, but minus the time consumed with the RTS/CTS frame interchange. There is no such limitation for the duration of the CTS-A frame, which is not responding to any RTS frame.

In some embodiments, a length of the channel-access period (or TXOP time) may be configurable. In some embodiments, the AP device adjusts, within the CTS-A frame, a length of the channel-access period to last through an expected period of time during which a subsequent RTS frame would be allowed to be transmitted by the peer wireless device. In this way, the channel-access period may be customized depending on how close to the end of the channel-on time is the receipt of the RTS frame.

FIG. 6B is the operational diagram of the exemplary VSDM operation of the AP device of FIG. 6A, illustrating a time period during which the CTS-A frame is to be sent out according to some embodiments. In some embodiments, the AP device transmits the CTS-A frame within a time period 650 defined by a combination of a CTS timeout period 640, a distributed inter-frame space (DIFS) 644, and a re-start back-off window 648 imposed on the peer wireless device. For example, the CTS timeout period 640 elapses waiting for a normal CTS frame that is not sent in favor of instead sending out the CTS-A frame. The DIFS period 644 may be understand as a mandatory waiting period that a device (e.g., the peer wireless device) has to wait before attempting to transmit data after a channel becomes free, e.g., to reduce the likelihood of collisions. The re-start back-off window 648 may be employed as part of the time period 650 to give the AP device more time to generate either a CTS frame or a CTS-A frame, and which further reduces collision chances.

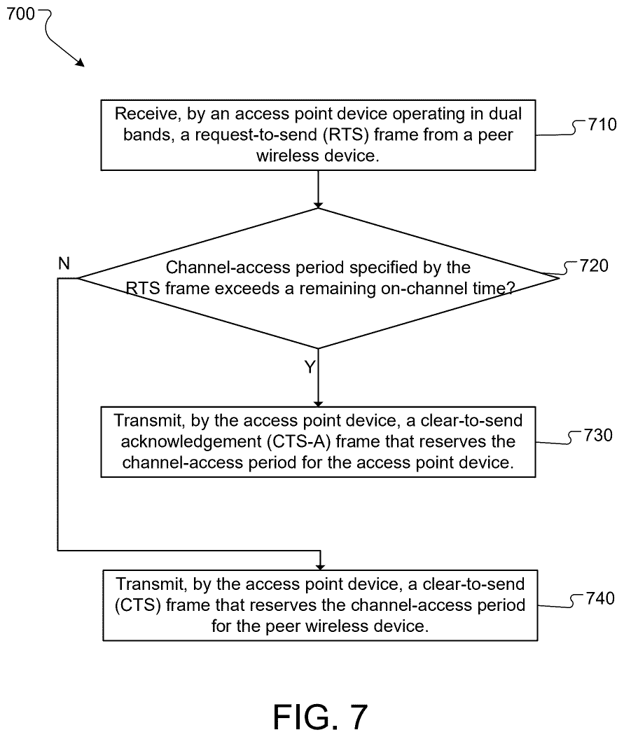

FIG. 7 is a flow chart of a method 700 for an AP device to conduct receiver defense using CTS-A frames according to some embodiments. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by a dual-AP device, e.g., processing logic of any AP device illustrated or discussed herein.

At operation 710, the processing logic receives a request-to-send (RTS) frame from a peer wireless device.

At operation 720, the processing logic determines whether a channel-access period specified by the RTS frame exceeds a remaining on-channel time for a wireless band during time-division multiplexing transmission.

At operation 730, the processing logic, in response to the channel-access period of the RTS frame exceeding the remaining on-channel time, transmits a clear-to-send acknowledgement (CTS-A) frame that reserves the channel-access period for the AP device.

At operation 740, the processing logic, in response to the channel-access period of the RTS frame not exceeding the remaining on-channel time, transmits a CTS frame in response to the RTS frame that reserves the channel-access period for the peer wireless device.

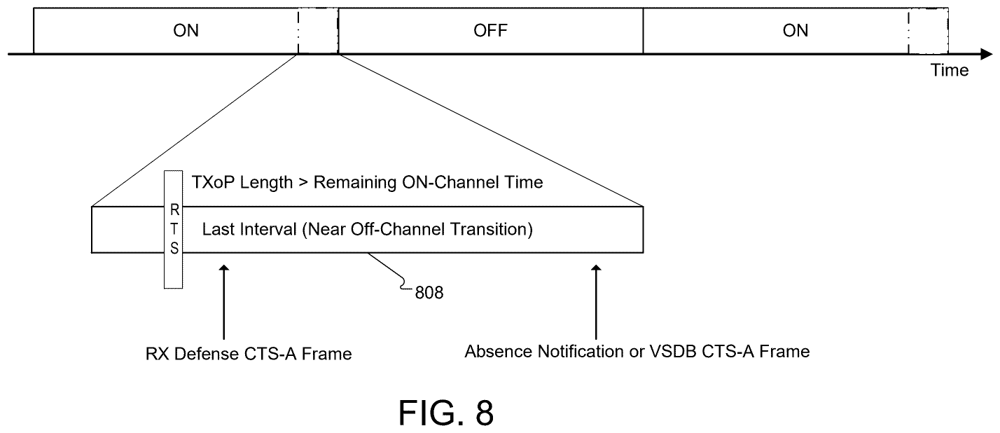

FIG. 8 is a timing diagram illustrating operation of the receiver defense when an active channel (e.g., a particular wireless band) is near an off-channel transition according to some embodiments. As illustrated, once the time left during an on-channel period (e.g., a last time interval 808) is such that the channel-access period requested in an RTS is greater than a remaining on-channel time, then the AP device may transmit the CTS-A frame as previously described. Transmitting the CTS-A frame may be with a shorter channel-access period sufficient to protect the remaining on-channel time so that the absence notification CTS-A frame may be sent by the AP device and received by the peer wireless device. In this way, the transition to the off-channel period is protected and peer wireless devices are not trapped continuing to try data transmission to the AP device over the channel that is currently off.

Thus, in some embodiments, the method 700 of FIG. 7 may further include transmitting, by the AP device, an absence notification CTS-A frame after the CTS-A frame and before an off-channel period of the wireless band. In some embodiments, a second channel-access period of the absence notification CTS-A frame is longer than the channel-access period of the CTS-A frame.

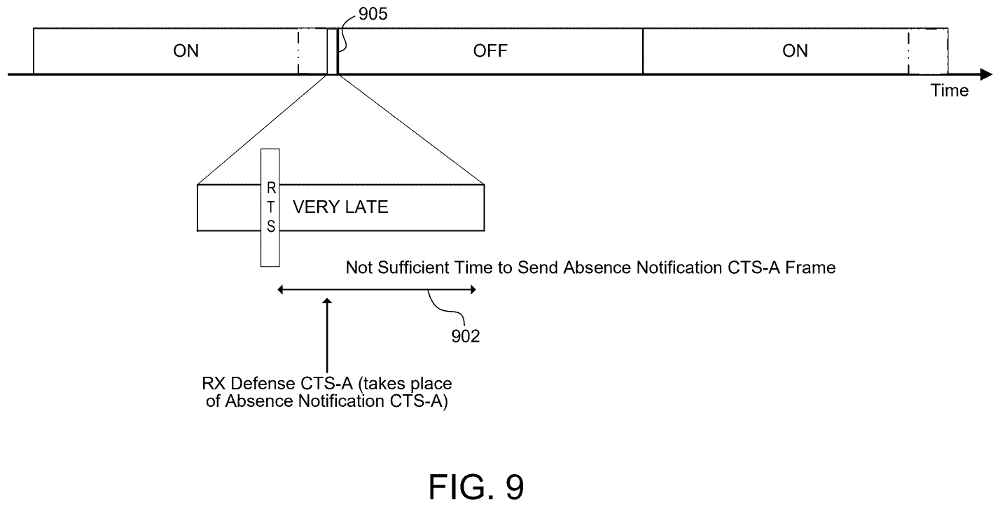

FIG. 9 is a timing diagram illustrating operation of the receiver defense when an on-channel time period of a first wireless band is within a predetermined period of ending according to at least one embodiment. For example, the AP device may determine that the on-channel time period is so close to ending, that only a short window of time 902 remains with which to transmit an absence notification CTS-A frame. In some embodiments, the short window of time 902 may be just a few milliseconds (ms), such as between 2-5 ms, 3-6 ms, or 3-7 ms. In these embodiments, the AP device, in response to detecting the on-channel time period of a first wireless band (e.g., Band1) is within a predetermined time of ending (e.g., within the short window of time 902 before an off-channel transition 905), transmits a CTS-A frame that reserves a channel-access period for the AP device. In this way, this defense CTS-A frame takes the place of the absence notification CTS-A frame. In some embodiments, the duration of the access-channel period is lengthened to match that of a typical absence notification CTS-A frame, e.g., via dynamic adjustment of the access-channel period.

In some embodiments, the AP device sets the channel-access period for the CTS-A frame to be as long as that of an absence notification CTS-A frame. In some embodiments, transmitting the CTS-A frame is in response to receipt, by the AP device, of an RTS frame from a peer wireless device. In alternative embodiments, with continued reference to FIG. 8, the AP device may also transmit an absence notification CTS-A frame after the CTS-A frame and before an off-channel period of the first wireless band, assuming there is sufficient time to do so. A second channel-access period of the absence notification CTS-A frame may be longer than the channel-access period of the CTS-A frame.

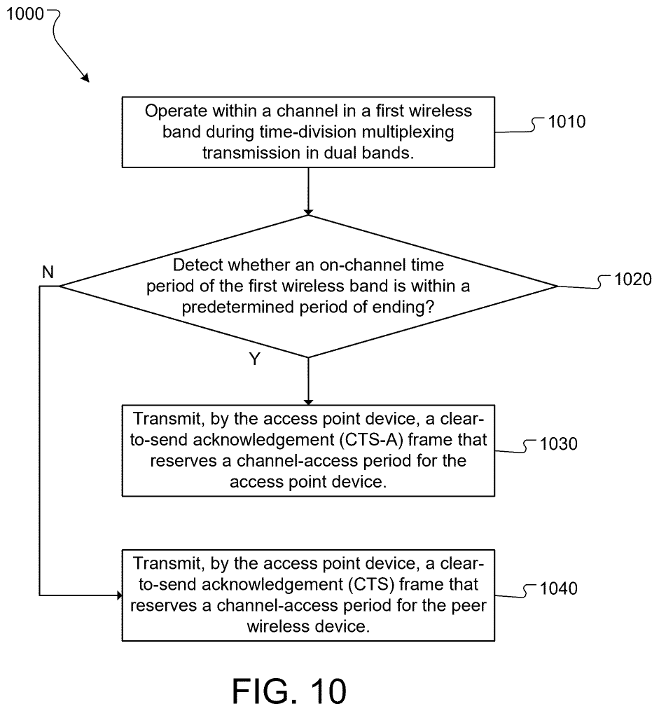

FIG. 10 is a flow chart of a method 1000 of the AP device conducting receiver defense depending on whether an on-channel time period of a first wireless band is within a predetermined period of ending according to at least one embodiment. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by a dual-AP device, e.g., processing logic of any AP device illustrated or discussed herein.

At operation 1010, the processing logic operates within (e.g., transmit data over) a channel in a first wireless band during time-division multiplexing transmission in dual bands.

At operation 1020, the processing logic detects whether an on-channel time period of the first wireless band is within a predetermined period of ending. This predetermined period may generally be a short time interval in which the AP device will likely not have sufficient time to send both a CTS-A frame and an absence notification CTS-A frame.

At operation 1030, the processing logic, in response to detecting in operation 1020 that the on-channel period is within the predetermined period of ending, transmits a clear-to-send acknowledgement (CTS-A) frame that reserves a channel-access period for the AP device.

At operation 1040, the processing logic, in response to detecting in operation 1020 that the on-channel period is not within the predetermined period of ending, transmits a CTS frame that reserve the channel-access period for the peer wireless device.

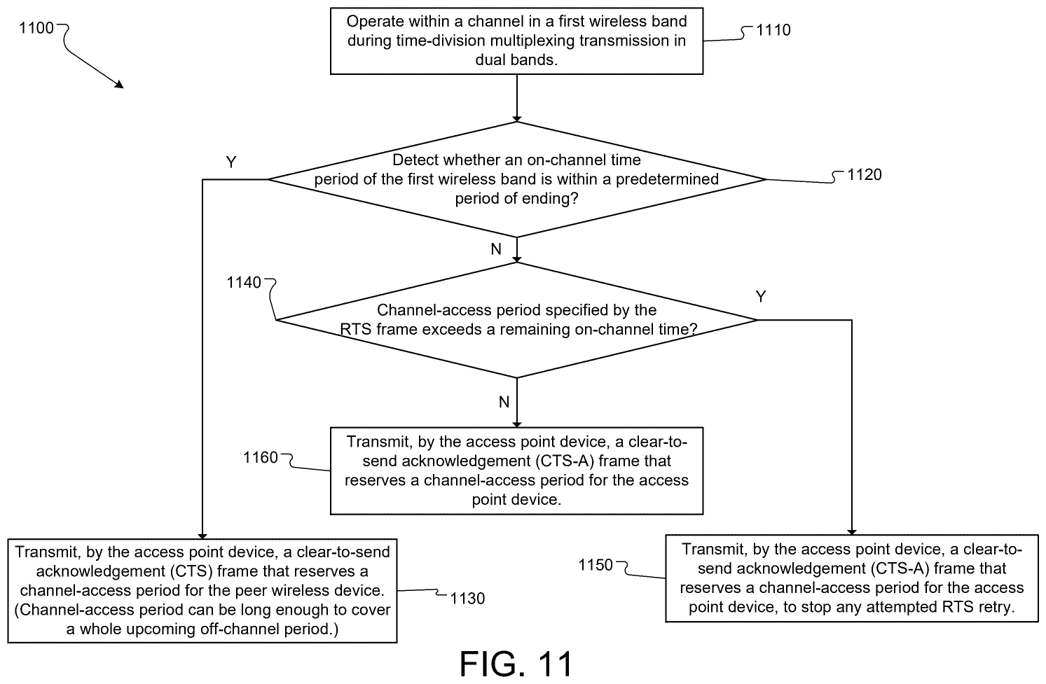

FIG. 11 is a flow chart of a method of the AP device conducting receiver defense when an on-channel time period of a first wireless band is within a predetermined period of ending according to some embodiments. The method 1000 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 1000 is performed by a dual-AP device, e.g., processing logic of any AP device illustrated or discussed herein.

At operation 1110, the processing logic operates within (e.g., transmit data over) a channel in a first wireless band during time-division multiplexing transmission in dual bands.

At operation 1120, the processing logic detects whether an on-channel time period of the first wireless band is within a predetermined period of ending. This predetermined period may generally be a short time interval in which the AP device will likely not have sufficient time to send both a CTS-A frame and an absence notification CTS-A frame.

At operation 1130, the processing logic, in response to detecting in operation 1020 that the on-channel period is within the predetermined period of ending, transmits a clear-to-send acknowledgement (CTS-A) frame that reserves a channel-access period for the AP device. In some embodiments, the channel-access period is long enough to cover a whole upcoming off-channel period.

At operation 1140, the processing logic determines whether a channel-access period specified by the RTS frame exceeds a remaining on-channel time for a wireless band during time-division multiplexing transmission.

At operation 1150, the processing logic, in response to the channel-access period of the RTS frame exceeding the remaining on-channel time, transmits a clear-to-send acknowledgement (CTS-A) frame that reserves the channel-access period for the AP device, e.g., to stop any attempted RTS retry. Thus, the reserved channel-access period at operation 1150 need not cover the whole upcoming off-channel period.

At operation 1160, the processing logic, in response to the channel-access period of the RTS frame not exceeding the remaining on-channel time, transmits a CTS frame in response to the RTS frame that reserves the channel-access period for the peer wireless device.

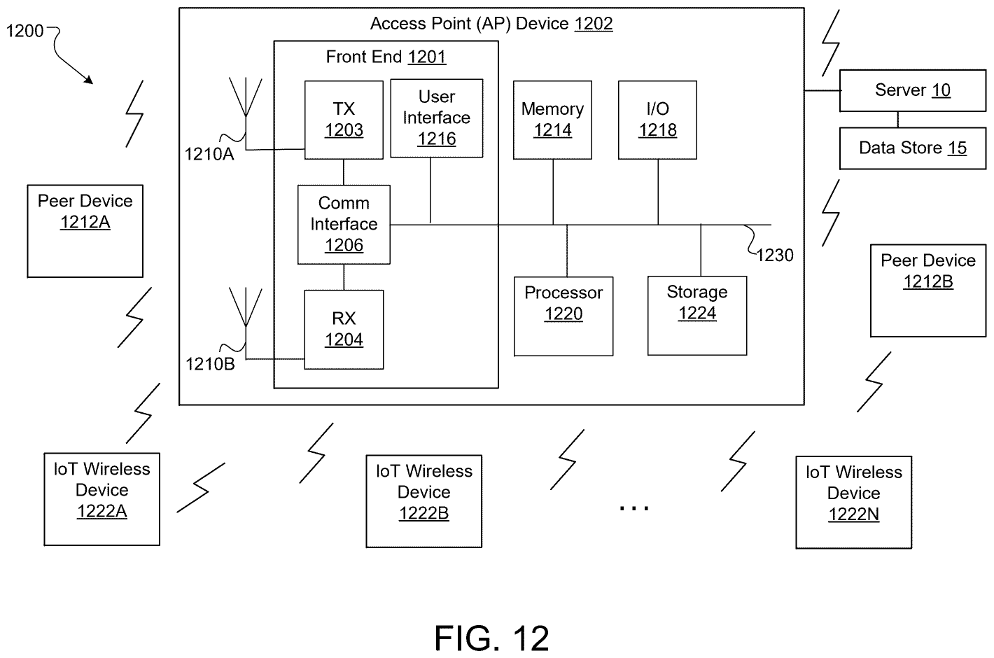

FIG. 12 is a simplified block diagram of a wireless network 1200 in which an example access point device (e.g., AP device 1202) interacts with other wireless devices according to various embodiments. The other wireless devices may include one or more peer devices 1212A, 1212B and one or more Internet-of-Things (IoT) devices 1222A, 1222B . . . 1222N, all of which may be understood to be possible peer wireless device as described herein.

In at least some embodiments, the AP device 1202 includes, but is not limited to, a front end 1201 having a transmitter 1203 or TX (e.g., a WLAN transmitter), a receiver 1204 or RX (e.g., a WLAN receiver), a communications interface 1206, and a user interface 1216. The AP device 1202 may further include at least one TX antenna 1210A coupled to the transmitter 1203, and at least one RX antenna 1210B coupled to the receiver 1204. In some embodiments, at least the transmitter 1203 and the receiver 1204 form a transceiver of the AP device 1202. In embodiments, the AP device 1202 includes two antennas for multiple input, multiple output (MIMO) operation of the transceiver, which may include switching circuitry to switch between the dual bands discussed herein, including for example, the 2.4 GHz and 5 GHz bands.

The AP device 1202 may further include a memory 1214, one or more input/output (I/O) devices 1218 (such as a display screen, a touch screen, a keypad, and the like), a processor 1220, and a storage device 1224. These components can all be coupled to a communications bus 1230 or multiple communication buses. In some embodiments, at least some of the components of the AP device 1202 are directly connected and may thus not be coupled through the communication bus 1230. Thus, illustration of the communication bus 1230 is not be taken as required or limiting for at least some of the components of the AP device 1202, which may directly intercommunicate. In some embodiments, aspects of the communication interface 1206 work with the processor 1220 to perform operations or that function as a processing device of the AP device 1202. In some embodiments, there is a single antenna and multiplexing logic to switch use of the antenna between the TX and RX.

In at least some embodiments, the memory 1214 and/or the storage device 1224 include computer storage to store instructions executable by the processor 1220 and/or data generated or accessed by the communication interface 1206. In various embodiments, frontend components such as the transmitter 1203, the receiver 1204, the communication interface 1206, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-Wave™, Zigbee®, LoRa™, Wi-SUN®, or other wireless protocol. While some of the wireless protocols may also be referred to as personal area network (PAN) technology, for simplicity, all are broadly referred to as WLAN technology. Future wireless protocols are also envisioned.

In various embodiments, the communication interface 1206 coordinates, as directed by the processor 1220, to request/receive packets from the other wireless devices or those that reflect off of objects. The communications interface 1206 can further process data symbols received by the receiver 1204 in a way that the processor 1220 can perform further processing, including identifying and parsing data packets received within the wireless signals.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
receiving, by an access point (AP) device operating in dual bands, a request-to-send (RTS) frame from a peer wireless device;
determining whether a channel-access period specified by the RTS frame exceeds a remaining on-channel time for a wireless band during time-division multiplexing transmission; and
in response to the channel-access period of the RTS frame exceeding the remaining on-channel time, transmitting, by the AP device, a clear-to-send acknowledgement (CTS-A) frame that reserves the channel-access period for the AP device.

2. The method of claim 1, further comprising adjusting, within the CTS-A frame, a length of the channel-access period to last through an expected period of time during which a subsequent RTS frame would be allowed to be transmitted by the peer wireless device.

3. The method of claim 1, wherein reserving the channel-access period with the CTS-A frame takes access to the channel-access period away from the peer wireless device.

4. The method of claim 1, further comprising generating the CTS-A frame with a destination address that is other than a source address included within the RTS frame and with a duration that is different than the duration in a CTS frame.

5. The method of claim 1, wherein the channel-access period is a transmission opportunity (TXoP) period for the wireless band.

6. The method of claim 1, wherein transmitting the CTS-A frame further comprises transmitting the CTS-A frame within a time period defined by a combination of a CTS timeout period, a distributed inter-frame space, and a re-start back-off window imposed on the peer wireless device.

7. The method of claim 1, further comprising transmitting, by the AP device, an absence notification CTS-A frame after the CTS-A frame and before a off-channel period of the wireless band.

8. The method of claim 7, wherein a second channel-access period of the absence notification CTS-A frame is longer than the channel-access period of the CTS-A frame.

9. A method comprising:
operating, by an access point (AP) device, within a channel, in a first wireless band during time-division multiplexing transmission in dual bands;
detecting that an on-channel time period of the first wireless band is within a predetermined period of ending; and
in response to the detecting, transmitting, by the AP device, a clear-to-send acknowledgement (CTS-A) frame that reserves a channel-access period for the AP device.

10. The method of claim 9, further comprising setting the channel-access period for the CTS-A frame to be as long as that of an absence notification CTS-A frame.

11. The method of claim 9, wherein transmitting the CTS-A frame is in response to receipt of an RTS frame from a peer wireless device.

12. The method of claim 11, further comprising transmitting, by the AP device, an absence notification CTS-A frame after the CTS-A frame and before an off-channel period of the first wireless band, wherein a second channel-access period of the absence notification CTS-A frame is longer than the channel-access period of the CTS-A frame.

13. An access point device comprising:
a transceiver configured to operate in dual bands; and
a processing device coupled to the transceiver, wherein the processing device is to:
cause the transceiver to receive, from a peer wireless device, a request-to-send (RTS) frame;
determine whether a channel-access period specified by the RTS frame exceeds a remaining on-channel time for a wireless band during time-division multiplexing transmission; and
in response to the channel-access period of the RTS frame exceeding the remaining on-channel time, cause the transceiver to transmit a clear-to-send acknowledgement (CTS-A) frame that reserves the channel-access period for the transceiver.

14. The access point device of claim 13, wherein the processing device if further to adjust, within the CTS-A frame, a length of the channel-access period to last through an expected period of time during which a subsequent RTS frame would be allowed to be transmitted by the peer wireless device.

15. The access point device of claim 13, wherein reserving the channel-access period with the CTS-A frame takes access to the channel-access period away from the peer wireless device.

16. The access point device of claim 13, wherein the processing device is further to generate the CTS-A frame with a destination address that is other than a source address included within the RTS frame and with a duration that is different than the duration in a CTS frame.

17. The access point device of claim 13, wherein the channel-access period is a transmission opportunity (TXoP) period for the wireless band.

18. The access point device of claim 13, wherein, to cause the transceiver to transmit the CTS-A frame, the processing device is further to cause the transceiver to transmit the CTS-A frame within a time period defined by a combination of a CTS timeout period, a distributed inter-frame space, and a re-start back-off window imposed on the peer wireless device.

19. The access point device of claim 13, wherein the processing device is further to cause the transceiver to transmit an absence notification CTS-A frame after the CTS-A frame and before an off-channel period of the wireless band.

20. The access point device of claim 19, wherein a second channel-access period of the absence notification CTS-A frame is longer than the channel-access period of the CTS-A frame.
